(19) United States
(12) Patent Application Publication
(10) Pub. No.: US 2010/0054687 A1
(43) Pub. Date: Mar. 4, 2010

(54) CABLE SLACK HANDLING DEVICE

(76) Inventors: Li Ye, Shanghai (CN); Bin Lu, Shanghai (CN); Rutesh D. Parikh, Austin, TX (US)

Correspondence Address: 3M INNOVATIVE PROPERTIES COMPANY, PO BOX 33427, ST. PAUL, MN, 55133-3427, US

(21) Appl. No.: 12/514,085

(22) PCT Filed: Oct. 4, 2007
(86) PCT No.: PCT/US07/80438

§ 371 Date: May 8, 2009

(30) Foreign Application Priority Data
Dec. 5, 2006 (CN) 200610164032.0

(51) Int. Cl. G02B 6/46; F16L 3/00

(52) U.S. Cl. 385/135; 248/49

(57) ABSTRACT

A cable slack handling device including a base portion with a first lobe and a second lobe each joined with the base portion. The first and second lobes each have an arcuate exterior wall portion to accommodate cable slack around a perimeter of the cable slack handling device. A connection device holder is located between a portion of the first and second lobes. The connection device holder is adapted to contain cable connection devices. The connection device holder has two opposite ends each adapted to receive cables.

### BACKGROUND

Cables of varying size and application are used in many industries, such as the telecommunications industry and the electrical industry. In the telecommunications field, for example, the use of optical fiber cables has become increasingly widespread throughout the fiber network. This expansion in the fiber network has resulted in an increasing number of optical fiber cables that must be spliced, connected, and distributed, thereby increasing the amount of cable slack needing to be handled, managed, organized, and/or stored. Conventional connection device trays, for example, as shown in FIG. 1, are generally oversized and provide inadequate handling and storing of cable slack extending from the connection device.

### SUMMARY

Embodiments of the invention can include, for example, a cable slack handling device having a base portion with a first lobe and a second lobe each joined with the base portion. Also, for example, the first and second lobes can each include an arcuate exterior wall portion to accommodate cable slack around a perimeter of the cable slack handling device. Also, for example, a connection device holder can be located between a portion of the first and second lobes. The connection device holder can contain cable connection devices, and the connection device holder can include two opposite ends to receive cables.

Additionally, for example, the invention can further include several cables and several cable connection devices. Also, for example, a connection device holder can be located between a portion of the first and second lobes. The connection device holder can contain cable connection devices, and the connection device holder can include two opposite ends to receive cables.

Additionally, embodiments of the invention can also include, for example, the aforementioned cable slack handling devices contained within a housing, tray, or drawer for telecommunication applications.

### BRIEF DESCRIPTION OF DRAWINGS

FIG. 1 is a top view of a prior version of a connection device tray.

FIG. 2 is a top view of a cable slack handling device holding a number of cables according to an embodiment of the invention.

FIG. 3A is an isometric view of a cable slack handling device according to an embodiment of the invention.

FIG. 3B is an isometric view of a cable slack handling device according to another embodiment of the invention.

FIG. 4 is a schematic top view showing dimensions of the cable slack handling device according to an embodiment of the invention.

FIG. 5 is a top view of a cable slack handling device showing dimensions according to an embodiment of the invention.

FIG. 6 is a top view of a cable slack handling device of FIG. 5 holding a number of cables according to an embodiment of the invention.

FIG. 7A is an isometric view of a cable slack handling device according to an embodiment of the invention.

FIG. 7B is an isometric view of a cable slack handling device according to another embodiment of the invention.

FIG. 8 is a schematic top view of a cable slack handling device showing dimensions according to an embodiment of the invention.

FIG. 9 is an isometric view of a cable slack handling device according to an embodiment of the invention.

FIG. 9A is a cross-sectional view showing a connection device holder of the cable slack handling device of FIG. 9.

FIG. 10A is a top view of a cable slack handling device mounted in a housing according to an embodiment of the invention.

FIG. 10B is a top view of a cable slack handling device mounted in a housing according to an embodiment of the invention.

FIG. 11 is a top view of a cable slack handling device mounted in a housing according to an embodiment of the invention.

FIG. 12 is a top view of a cable slack handling device mounted in a housing according to an embodiment of the invention.

### DETAILED DESCRIPTION

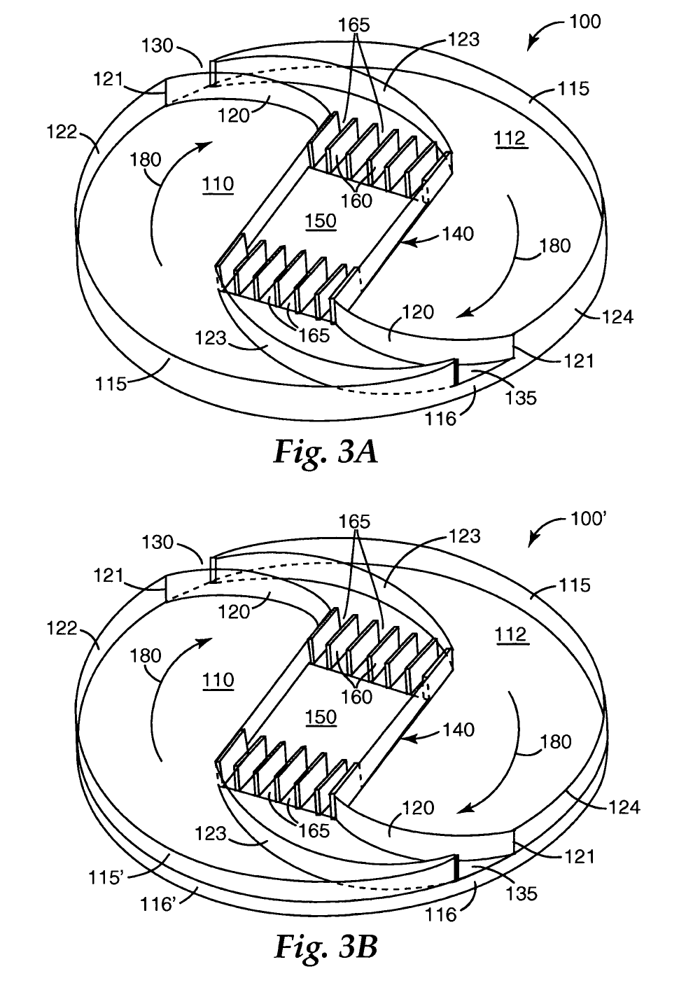

The invention relates to a cable slack handling device, such as device 100 shown in FIG. 3A, for splicing, connecting, and distributing multiple cables, and efficiently handling, managing, organizing, and/or storing the corresponding cable slack around a compact structure. The cable slack handling device 100 can be used in applications such as, for example, telecommunication networks using fiber optic ribbon cables. The cable slack handling device 100 can accommodate various lengths of slack fiber in an orderly fashion without the need for a supplemental basket and without risk of damaging the cables. Therefore, the cable slack handling device 100 can effectively reduce the space required for appropriate cable slack storage.

The cable slack handling device 100 can assist with any form of connection, including but not limited to, for example, splicing, splitting, connecting, distributing, and/or any other suitable connection in the telecommunications or electrical industry. The connection is formed by a connection device, including but not limited to, for example, mechanical or fusion splices, splitters, couplers, connectors, passive optical devices, or other suitable connection devices in the telecommunications or electrical industry. Furthermore, a connection device holder is any type of holder which can hold the connection device.

The remainder of this description will refer only to the preferred embodiment of splicing using preferably a mechanical or fusion splice, but skilled artisans will recognize that application of the cable slack handling device 100 can be used for all of the other aforementioned connections and connection devices in various industries.

The various embodiments of the cable slack handling devices described herein can be used in various applications and can be used in cooperation with various housings and other known cable management devices such as closures, splice trays, field trays, cabinet drawers, fiber management drawers, rack structures, and other such devices. This compact structure, for example, can be installed in a housing, closure, drawer, or cassette to facilitate connection to telecommunications equipment, or alternatively can be installed in a splice tray to facilitate connection of one set of telecommunication lines (e.g., distribution lines) and another set of telecommunication lines (e.g., jumpers).

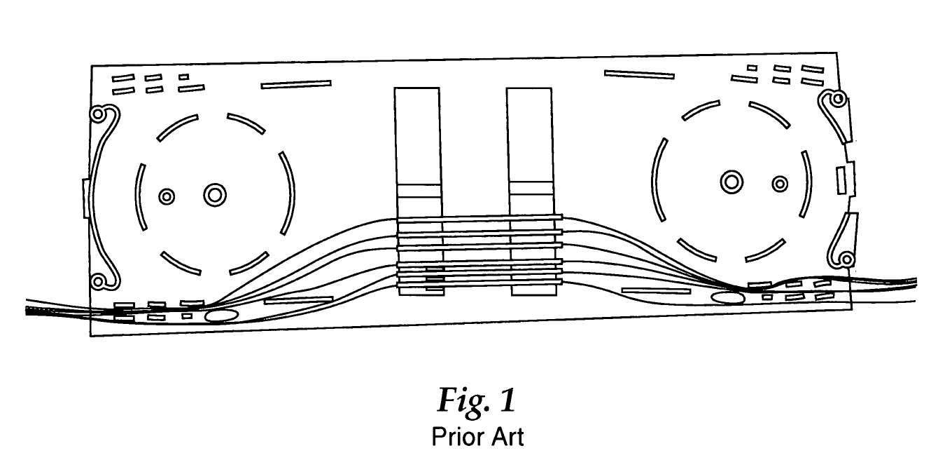

A conventional splice tray (e.g., a 2533 splice tray available from 3M Company, St. Paul, Minn.) is shown schematically in FIG. 1. Conventional designs typically utilize a straight cable path when used for optical fiber ribbon cable and have little or no room to accommodate storage of the slack length of such cables. In order to accommodate storage of additional lengths of slack cable, an additional separate slack basket is often required to be used. In some applications having limited space (e.g., telecommunication closures and drawers in an MDF), the additional space taken up by the slack basket limits the number of splice trays that can be used. For example, the tray shown in FIG. 1 allows for only a short length of cable (e.g., less than about 30 cm) to be stored in the splice tray, while any remaining slack must be stored in a separate slack basket. Additionally, if the slack cable from multiple splice trays is retained in a single slack basket, tangling or snarling of the ribbon cables can occur which can result in accidental damaging of cables.

FIGS. 3-6 illustrate exemplary embodiments of the cable slack handling device 100, 100′. For example, a cable slack handling device 100 can include a base portion 116 (116′) supporting a first lobe 110, a second lobe 112, and a splice holder 140. The splice holder 140 can be positioned between the first lobe 110 and the second lobe 112, and the splice holder 140 can include one or more splices 170 to connect cables between the lobes 110, 112. Collectively, the base portion 116 (116′), the lobes 110, 112, and the splice holder 140 can serve as a compact structure that can efficiently handle cable slack in a confined or limited space.

The lobes 110, 112 can include, for example, vertical partitions 115 that form walls extending away from or rising from the base portion 116 (116′), for example in a perpendicular relationship to the base portion 116. The vertical partitions 115 define the size and shape of the first and second lobes 110, 112, which can be formed in any shape that maintains proper minimum bend radius of the cables, but which are typically of equal dimensionality. The vertical partitions 115 of each lobe form the interior and exterior walls of each lobe preferably having a round shape with a radius not smaller than minimum bending radius of stored fibers. Examples of the vertical partitions 115 can be in the form of arcuate interior walls 120, 123 and arcuate exterior walls, 122, 124 which collectively form the walls of each of the first and second lobes 110, 112.

The vertical partitions 115 of the lobes 110, 112 can be joined with the base portion 116 (116′) indirectly, directly, or integrally. For example, in FIG. 3A, the first and second lobes 110, 112 are joined with the base portion 116 in an integral fashion, as may be achieved by injection molding the lobes 110, 112 and the base portion 116 as a single unit. Also, for example, in FIG. 3B, the first and second lobes 110, 112 are joined with the base portion 116′ in a direct connection, as may be achieved by using an adhesive, mechanical connection, welding, or other connection to connect the individual lobes 110, 112 to the base portion 116′.

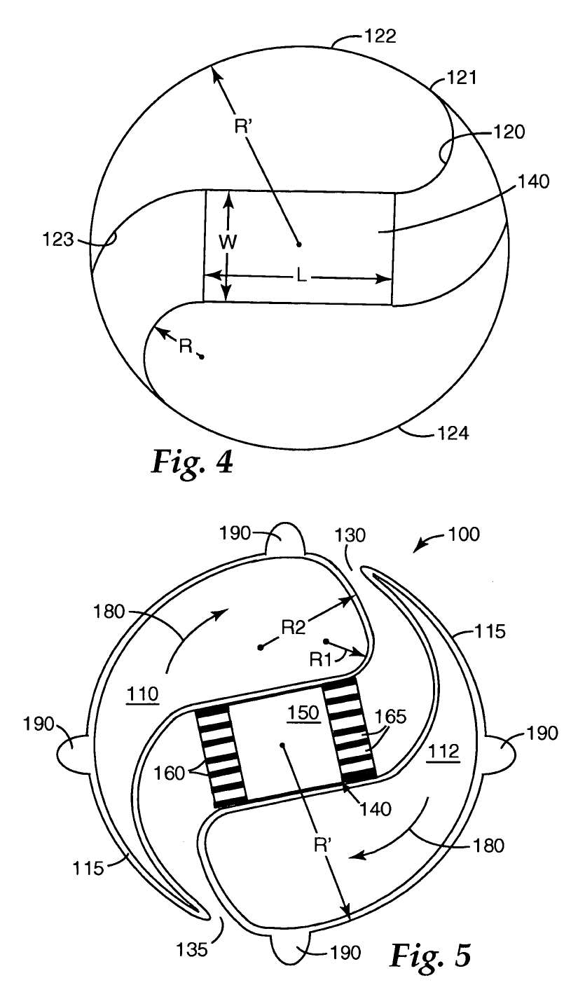

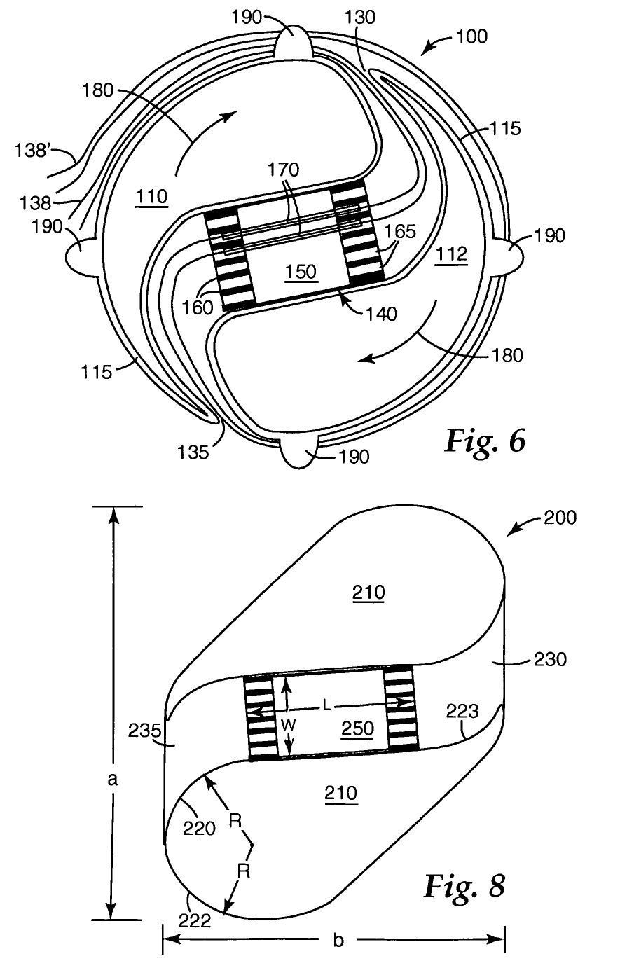

The first lobe 110 and second lobe 112 each have a pair of arcuate interior walls 120, 123. A portion of at least one of the arcuate interior walls 120, 123 of each lobe 110, 112 can have a radius of curvature R, as shown in the cable slack handling device of FIG. 4. Alternatively, for example, as shown in FIG. 5, a portion of at least one of the arcuate interior walls 120 of each lobe 110, 112 can have a radius of curvature R1, and another portion of at least one of the arcuate interior walls 120 of each lobe 110, 112 can have a radius of curvature R2. Structural embodiments may have varying values for R depending on the minimum bend radius of the cable being used. Preferably, the value for R (i.e., R, R1, R2, etc.) would be substantially similar to the minimum bend radius of the cable being utilized, for example, less than or about 30 mm, to thereby establish the most compact efficient structure for handling cable slack. Embodiments of cables may have minimum bend radii, for example, of 30 mm, 15 mm, or 7.5 mm, in which case a portion of at least one of the arcuate interior walls 120, 123 of each lobe 110, 112 would have a corresponding radius of curvature, for example, of 30 mm, 15 mm, or 7.5 mm, respectively.

Also shown in FIGS. 3-5, the first and second lobes 110, 112 each have an arcuate exterior wall portion 122, 124 configured to accommodate cable slack around the perimeter of the cable slack handling device 110, 112. The arcuate exterior wall portions 122 of the first and second lobes 110, 112 can have a radius of curvature R′. Structural embodiments may have varying values for R′. For example, the value for R′ can be that which is necessary to achieve a substantially circular structure for the entire cable slack handling device 100, 100′. In such an arrangement, for example, the arcuate exterior wall portion 122 of the first lobe 110 and the arcuate exterior wall portion 124 of the second lobe 112 can cooperate to form a substantially circular circumferential configuration to accommodate cable slack in a substantially circular arrangement. Embodiments can include, for example, as shown in FIGS. 3-5, the arcuate interior walls 120, 123 of the first and second lobes 110, 112 having a radius of curvature R that is less than the radius of curvature R′ of the arcuate exterior wall portions 122, 124 of the first and second lobes 110, 112. The radius of curvature R, in any event, is preferably not smaller than the minimum bend radius of the fiber used in cooperation with a particular embodiment of the lobes 110, 112.

Embodiments can also include a first channel 130 and a second channel 135 disposed between the lobes 110, 112 on opposite sides of the cable slack handling device 100, 100′. The channels 130, 135 receive the cables and lead the cables from the perimeter of the cable slack handling device 100, 100′ to or from the splice holder 140 disposed between the lobes 110, 112 and between the channels 130, 135. Embodiments of the invention also include a junction point 121 where each channel begins along the perimeter of the cable slack handling device 100, 100′. The junction point 121 indicates point of demarcation between one arcuate exterior wall 122, 124 and another adjacent arcuate interior wall 120, 123.

The channels 130, 135 begin at the junction point 121 between the arcuate exterior wall portions 122, 124 of the first and second lobes 110, 112. The channels continue toward the interior of the cable slack handling device 100 between the arcuate interior wall portions 120, 123 of the first and second lobes 110, 112. For example, each lobe 110, 112 has a first arcuate interior wall 120, and each lobe 110, 112 has a second arcuate interior wall 123. The arcuate interior wall portions 120, 123 of the first and second lobes 110, 112 can guide a number of cables through each of the pair of channels 130, 135 toward the cable splices held within the splice holder 140. The width of each channel 130, 135 between the first lobe and the second lobe is less than or substantially equal to the width of the splice holder 140.

Referring to FIG. 4, the splice holder 140 has a width W and a length L. In some embodiments, the minimum value for R′ may be the lesser value of: 1) twice the radius R plus half of the width of the splice holder 140 (2R+½ W), and 2) the radius R plus half the length of the splice holder 140 (R+½ L). In other embodiments, the minimum value for R′ may be at least the value of R+√[((W+R)/2)²+(L/2)²]. Embodiments can also include, for example, the shape of the vertical partitions 115 of the first lobe 110 being substantially similar to the shape of the “yin” in the Chinese symbol “yin-yang,” and the shape of the vertical partitions 115 of the second lobe 112 being substantially similar to the shape of the “yang” in the Chinese symbol “yin-yang.”

Embodiments of the splice holder 140, for example, can include a base 150 of the splice holder 140 on which the cable splices are located, and two opposite ends to receive a number of cables. The opposite ends of the splice holder 140 can include a number of flexible splice walls 160 between which a number of cable splices are secured. The splice walls 160 extend generally perpendicular from the base 150 of the splice holder 140. The splice walls 160 can be substantially linear or alternatively curved in shape. The splice walls 160 form a series of grooves 165 therebetween for receiving splices 170 (see FIG. 6), such as fiber optic splices in the form of mechanical splices, fusion splices, or alternatively other types of splices. The splice holder 140 can comprise various alternative splice holders, both conventional or otherwise.

Embodiments of the cables can be, for example, fiber optic cables. The fiber optic cables can include single fiber cables, multi-fiber cables, or fiber optic ribbon cables, or preferentially fiber optic ribbon cables having at least two optical fibers. The splice holder 140 is selected to match the type of splice used to connect each fiber optic cable. For example, if a single optical fiber cable is used, a splice holder 140 capable of holding discreet splices can be used (e.g., 2521F Fusion Splice Insert or 2521-FL 3M™ Fibrlok™ Splice Inserts available from 3M Company, St. Paul, Minn.). If a multi-fiber cable or ribbon cable is used then a splice holder 140 can be capable of accommodating mass fusion splices (e.g., 2521RF Ribbon Fusion Splice Insert) or mass mechanical splices (2521-FL 3M™ Fibrlok™ Multi-Fiber Splice Insert available from 3M Company, St. Paul, Minn.).

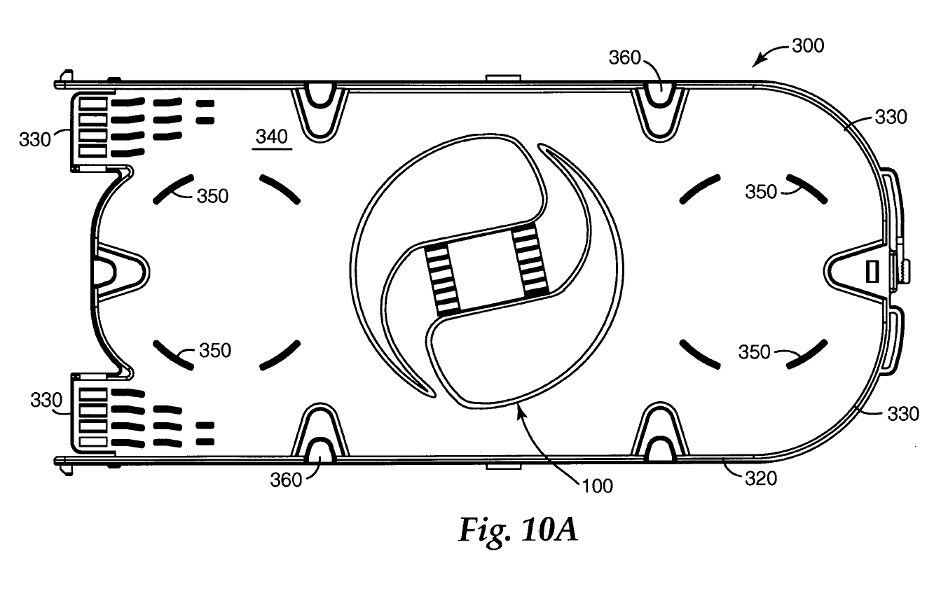

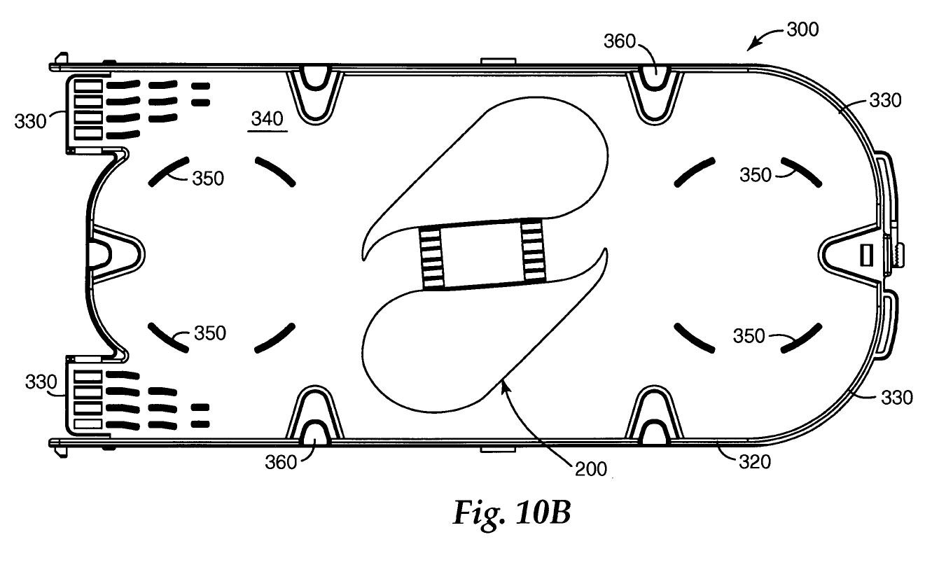

The cable slack handling device 100 can be made of a material that is inexpensive to manufacture yet resilient enough to withstand ordinary wear and tear. For example, flame retardant plastic can be used as the material for the first and second lobes 110, 112, the splice holder 140, as well as for any housings 300 (see FIG. 10) that are used in cooperation with the cable slack handling device 100, 100′. Alternatively, other various materials can be used for each feature of the cable slack handling device 100, 100′.

In operation, referring to the exemplary embodiment of FIG. 6, for example, the cable slack handling device 100 can store cable slack for a number of cables along the perimeter of the first and second lobes 110, 112. A first fiber optic ribbon cable 138 enters the cable slack handling device 100 through a first channel 130 and is spliced to a second fiber optic ribbon cable 138′ using a multi-fiber fusion splice 170. The completed fusion splice is housed in a slot 165 in splice holder 140 which is secured in the center of the cable slack handling device 100 between the first and second lobes 110, 112. The second fiber ribbon cable 138′ exits the fiber cable slack handling device through a second channel. The cable slack handling device 100 thereby allows the splicing of at least one optical fiber to at least one other optical fiber. Examples of the optical fibers can be in the form of optical ribbon fiber cables or multi-fiber cables. An additional amount of slack ribbon cable may be stored by wrapping around the outside diameter of the cable slack handling device 100 as shown by rotating as indicated by directional arrows 180 (arrows can be bidirectional on the drawings as well). The cable slack handling device 100 may optionally have several ears or tabs 190 formed on at least one of the upper or the lower surfaces of the vertical partitions 115 as a further cable or fiber management aide such to contain the cables properly within the exterior walls of the cable slack handling device 100. In some embodiments, ears or tabs can optionally be included within the channels 130, 135.

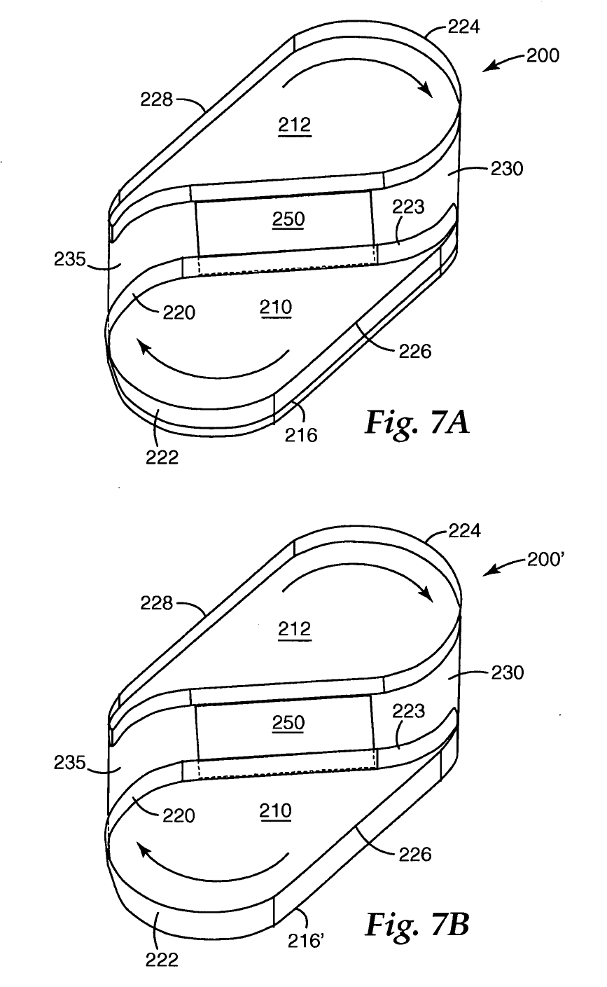

An alternative exemplary embodiment is illustrated by FIGS. 7A, 7B, and 8. A cable slack handling device 200 can include lobes 210, 212 formed thereon. The lobes 210, 212 can include, for example, vertical partitions 215 extending away from or rising from the base portion 216 (216′). Examples of the vertical partitions 215 can be in the form of arcuate interior walls 220, 223 and arcuate exterior walls, 222, 224 which collectively form the walls of each of the first and second lobes 210, 212.

The first lobe 210 and the second lobe 212 are each joined with the base portion 216 (216′). The lobes 210, 212 can be joined with the base portion 216 (216′) indirectly, directly, or integrally. For example, in FIG. 7A, the lobes 210, 212 are joined with the base portion 216 in a direct connection. Also, for example, in FIG. 7B, the lobes 210, 212 are joined with the base portion 216′ in an integral fashion.

The first and second lobes 210, 212 each have a pair of arcuate interior walls 220, 223. A portion of at least one of the arcuate interior walls 220, 223 of each lobe 210, 212 can have a radius of curvature R. Preferably, as shown in FIG. 8, the first and second lobes 210, 212 maintain a radius R for the entire length of the arcuate interior walls 220, 223. Structural embodiments may have varying values for R depending on the minimum bend radius of the cable being used. Preferably, the value for R would be substantially similar to the minimum bend radius of the cable being utilized, for example, less than or about 30 mm, to thereby establish the most compact efficient structure for handling cable slack. Embodiments of cables may have minimum bend radii, for example, of 30 mm, 15 mm, or 7.5 mm, in which case a portion of at least one of the arcuate interior walls 220, 223 of each lobe 210, 212 would have a corresponding radius of curvature, for example, of 30 mm, 15 mm, or 7.5 mm, respectively. Embodiments also include channels 230, 235 between the arcuate interior wall portions 220, 223 through which the cables pass. The channels 230, 235 lead the cables from the perimeter of the cable slack handling device 200 to the splice holder 250 between the lobes 210, 212.

Also shown in FIGS. 7A, 7B, and 8, for example, the first and second lobes 210, 212 each include an arcuate exterior wall portion 222, 224 configured to accommodate cable slack around the perimeter of the cable slack handling device 210, 212. The arcuate exterior wall portions 222, 224 of the first and second lobes 210, 212 have a radius of curvature substantially equal to the radius of curvature of the arcuate interior wall portion 220, 223 of the first and second lobes 210, 212. Additionally, as shown in FIGS. 7A, 7B, and 8, for example, the first and second lobes 210, 212 each also include a linear exterior wall portion 226, 228 having a substantially planar surface (i.e., a radius of curvature substantially equal to zero) to accommodate cable slack around the perimeter of the cable slack handling device 210, 212. In an exemplary aspect, the linear exterior wall portions 226, 228 of the first and second lobes 210, 212 are substantially parallel to each other.

Embodiments can include a pair of channels 230, 235 disposed between the lobes 210, 212 on opposite sides of the cable slack handling device 200, 200′. The channels 230, 235 begin at the junction point between the arcuate exterior wall portions 222, 224 of the first and second lobes 210, 212. The channels continue toward the interior of the cable slack handling device 200 between the arcuate interior wall portions 220, 223 of the first and second lobes 210, 212. The width of each channel 230, 235 between the first lobe and the second lobe is less than or substantially equal to the width of the splice holder 250.

As shown in FIG. 8, the splice holder 250 has a width W and a length L. The cable slack handling device as a whole has a width “a” and a length “b.” In this embodiment, the minimum value for the width “a” is four times the radius R plus the width of the splice holder 250 (4R+W). In this embodiment, the minimum value for the length “b” is twice the radius R plus the length of the splice holder 250 (2R+L).

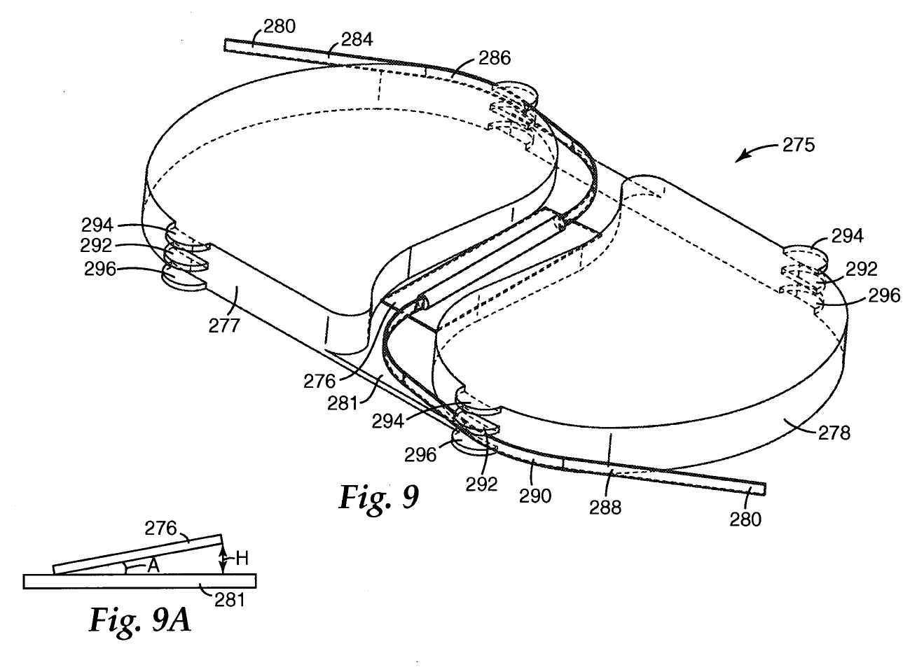

Another alternative embodiment is shown in the cable slack handling device 275 of FIG. 9. In this exemplary embodiment, the splice holder 276 can be positioned at an angle “A” relative to the base portion 281 (see FIG. 9A). To achieve this effect, for example, one end of the splice holder 276 can be supportably raised to a height “H” above the base portion 281, while the other end of the splice holder 276 can remain in contact with the base portion 281. The splice holder 276 can be angled in such a way to direct an input end 284 of the cables 280 in an input path 286 around the exterior wall portions of the lobes 277, 278 and to direct an output end 288 of the cables 280 in an output path 290 around the exterior wall portions of the lobes 277, 278. In operation, the angled splice holder 276 effectively separates the input path 286 of the input end 284 of the cables 280 from the output path 290 of the output end 288 of the cables 280.

Also, for example, in FIG. 9, the paths can be defined by a number of protuberances, ears, or tabs extending radially outward from the exterior wall portion of the lobes 277, 278. The ears or tabs can include, for example, a series of center protuberances 292, a series of first upper protuberances 294 on one side of the center protuberance 292, and a series of second lower protuberances 296 on the other side of the center protuberances 292. In operation, the space between the first or upper protuberances 294 and the center protuberance 292 defines the input path 286 of the input end 284 of the cables 280, and the space between the second or lower protuberances 296 and the center protuberance 292 defines the output path 290 for the output end 288 of the cables 280.

As shown in FIG. 10A, for example, the cable slack handling device 100 can be used with a housing 300 that includes a splice tray that is adapted to facilitate connection between one set of telecommunication lines and another set of telecommunication lines. The housing 300 can include a base plate 340 and side walls 320.

The housing 300 or splice tray can further include cable guide structures 350 to assist in routing the cables through the openings 330 in the proper direction, as well as tabs 360 for retaining the cables within the housing 300.

In FIG. 10A, for example, the base portion 116 (116′) of the cable slack handling device 100 can be rotatably connected or attached to the housing or closure 300 to enable the cable slack handling device 100 to spin about a central axis in the direction of arrows 180 (see FIG. 3A) when cable slack is either added or removed around the perimeter of the lobes 110, 112 of the cable slack handling device 100. Alternatively, the cable slack handling device 100 can be fixedly or rigidly connected to the housing or closure 300. Also, for example, the cable stack handling device 100 can be attached to a receiving member by an adhesive or double sided tape such as VHB tape available from 3M Company, St. Paul, Minn., or by mechanical means such as a snap fit, mechanical fastener, ultrasonic welding, gluing, or by any other suitable manner.

FIG. 10B illustrates a similar structure as FIG. 10A, illustrating that many different variations of cable slack handling devices, such as for example cable slack handling device 200, can be used in cooperation with the housing 300.

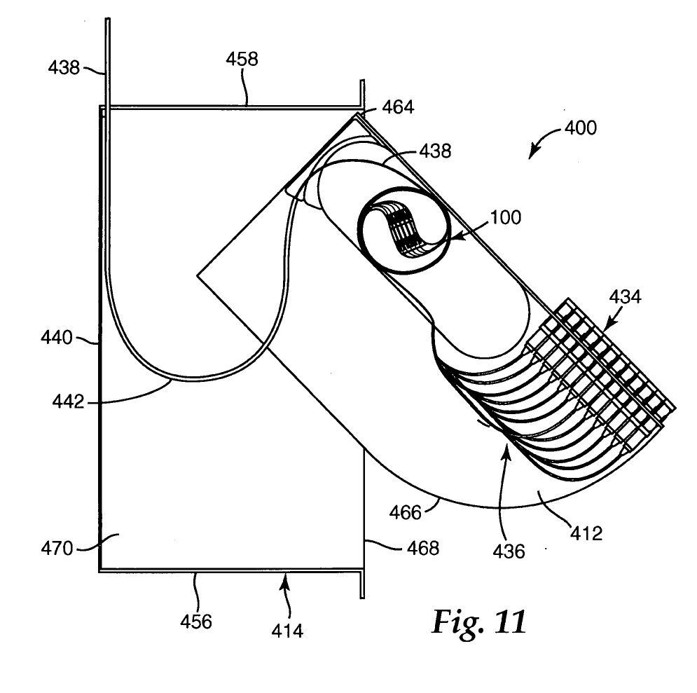

In addition, embodiments of the cable slack handling device 100 can be used in a drawer housed in a modular distribution frame or rack. For example, as shown in FIG. 11, the cable slack handling device 100 can be used with a housing that includes a rotatable drawer assembly 400 that is adapted to facilitate connection to telecommunication equipment. The excess cable slack in FIG. 11 is wound around the perimeter of the cable slack handling device 100 to facilitate storage of the excess cable.

In this example, FIG. 11 provides a top view of an individual drawer 412 arranged in a housing 414. The drawer 412 can be attached to the housing on an axis 464 on a side of the side wall 458. In this case, an opposite side of drawer 412 is provided with a rounded corner 466, which is designed to enable the drawer 412 to move in and out of housing 414. Line 468 indicates a boundary of the housing 414, which can be either the next drawer or a horizontal separation wall 470 between two adjacent drawers. Whether such an additional wall is necessary depends on the detailed requirements involved in the application of the drawer assembly 400. The drawer assembly 400 can be designed with any given number of drawers 412, so that it can be assembled onto a modular optical distribution frame (MODF).

FIG. 11 shows one arrangement within a drawer that utilizes a fiber cable slack handling device. An array 434 of fiber optic connection devices is shown. Each connection device can be connected to an optical fiber in the fiber fanout assembly 436. An incoming optical fiber ribbon cable 438 can enter the housing 414 at the rear side 440 of the housing 414. It should be understood that a plurality of optical fiber ribbon cables 438 can be utilized. In an exemplary embodiment, a typical fiber ribbon cable 438 contains several (e.g., often from 4 to 12 or more) optical fibers. Inside the drawer the incoming optical fiber ribbon cable can be bent typically in different directions so that the cable reaches the fiber cable slack handling device 100 which can be mounted to the rear side 440 of the housing 414. The incoming fiber optic ribbon cable can be joined to the fiber fanout assembly 436 by an optical splice which is held in the splice holder of the fiber cable slack handling device 100. Preferably, a fan-out assembly provides a well-defined distribution of fibers so that each individual fiber can be joined to the desired connection device in the connection device array 434.

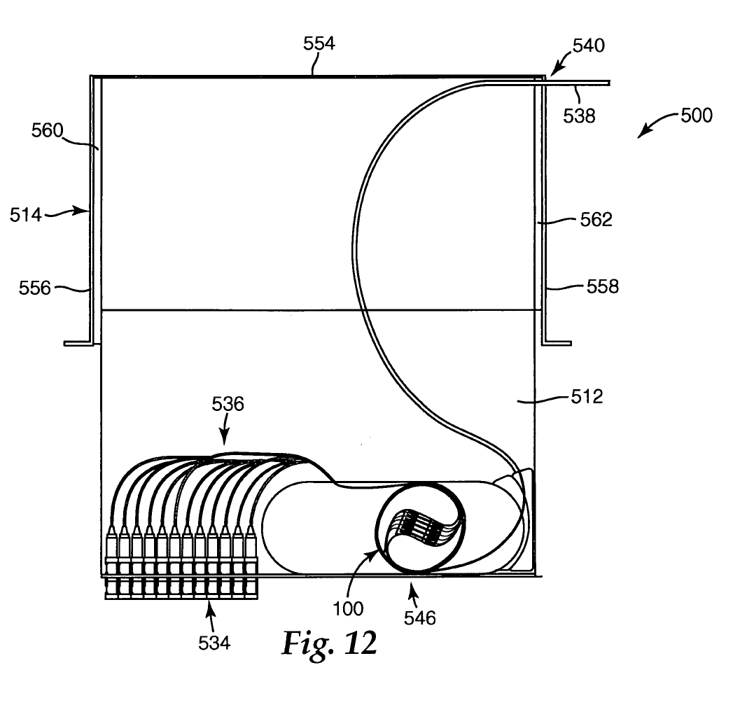

In yet another aspect, for example, as shown in FIG. 12, the cable slack handling device 100 can be used with a housing that includes a linearly sliding drawer assembly 500 that is adapted to facilitate connection to telecommunication equipment. The excess cable slack in FIG. 12 can be wound around the perimeter of the cable slack handling device 100 to facilitate storage of the excess cable.

Assembly 500 can include a housing 514, a drawer 512 with an array of fiber optic connection devices 534, and a fiber optic splicing cassette 546 including a fiber cable slack handling device 100. Assembly 500 can also include an internal fiber wiring fanout 536 and the incoming optical fiber ribbon cable 538, which enters housing 514, preferably on the rear side 540. The housing 514 can include a rear wall 554 and side walls 556, 558.

Rails 560, 562 can be attached onto the side walls 556, 558 so that the drawer can be moved onto these rails. This configuration can be utilized for each drawer within the system. Preferably, the rails 560, 562 are of the standard type and the drawers 512 moves along these rails in a known manner. Also, the rails can be provided with a blocking mechanism to prevent the drawer from falling off the housing if the drawer is extended too far. There also can be variations, for example, which can allow a user to remove the drawer and reinsert it in a controlled manner, as with conventional drawers. This operation can be useful if there is a need to assemble fibers in drawers that should be completely taken out of the housing 514, to provide additional working space for a user.

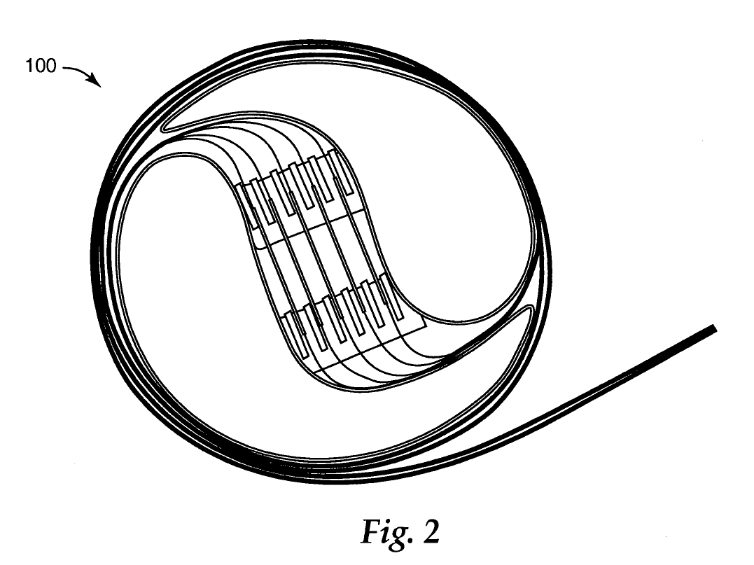

The fiber optic ribbon cable 538 can enter the cable slack handling device 100 and can be spliced to a fiber fanout assembly 536 using a multifiber fusion splice technique. The completed fusion splice can be housed in a slot 165 in a splice holder 140 (see FIG. 3A) which is secured in the center of fiber cable slack handling device 100. Alternatively, a mechanical splicing approach can be utilized. The fiber cable slack handling device of this embodiment would allow the splicing of a plurality ribbon fiber cables 538 to a plurality of fiber fanout assemblies 536 which could be directed to a greater number of optical connection device arrays 534. An additional amount of slack ribbon cable may be stored by wrapping around the outside diameter of the fiber cable slack handling device as shown in FIGS. 2 and 6.

In operation, the cable slack handling device of the embodiments described herein provides an improved structure for splicing, connecting, and distributing multiple cables, while efficiently handling, managing, organizing, and/or storing the corresponding cable slack around a compact structure. The compact structure advantageously reduces the space required for cable slack storage. The cable slack handling device can store long lengths of cable slack in an orderly fashion without the need for a supplemental basket. The cable slack handling device can be configured to a predetermined radius of curvature to minimize the risk of damaging the cables. The cable slack handling device can cooperate with other known cable management devices, such as fiber optic splice trays, fiber management drawers and/or cassettes, and other such devices.

Although the aforementioned detailed description contains many specific details for purposes of illustration, anyone of ordinary skill in the art will appreciate that many variations, changes, substitutions, and alterations to the details are within the scope of the invention as claimed. Accordingly, the invention described in the detailed description is set forth without imposing any limitations on the claimed invention. For example, any reference to terms such as mounted, connected, attached, joined, coupled, etc. should be construed broadly so as to include such mounting, connecting, attaching, joining, coupling, etc. as having been achieved indirectly, directly, and/or integrally. The proper scope of the invention should be determined by the following claims and their appropriate legal equivalents.

1. A cable slack handling device comprising:
a base portion;
a first lobe and a second lobe each joined with the base portion;
at least one arcuate exterior wall portion on each of the first and second lobes, the arcuate exterior wall portions adapted to accommodate cable slack around a perimeter of the device;
at least two interior wall portions on each of the first and second lobes defining a first channel and a second channel disposed between the first and second lobes, the first and second channels adapted to receive one or more cables; and
a connection device holder disposed between at least a portion of the first and second lobes and disposed between at least a portion of the first and second channels, the connection device holder adapted to contain one or more connection devices that receive the cables from the channels.

2. The device as defined by claim 1, wherein the width of each channel between the first lobe and the second lobe is less than or substantially equal to the width of the connection device holder.

3. The device as defined by claim 1, wherein the arcuate exterior wall portion of the first lobe and the arcuate exterior wall portion of the second lobe cooperate to form a substantially circular exterior wall configuration to accommodate cable slack in a substantially circular arrangement.

4. The device as defined by claim 1, wherein a part of each of the interior wall portions of the first and second lobes is arcuate and has a radius of curvature less than the radius of curvature of the arcuate exterior wall portions of the first and second lobes.

5. (canceled)

6. The device as defined by claim 1, wherein a part of each of the interior wall portions of the first and second lobes has a radius of curvature substantially equal to the radius of curvature of a part of the arcuate exterior wall portions of the first and second lobes, wherein the first and second lobes further comprise a linear exterior wall portion having a substantially planar surface and adapted to accommodate cable slack around the perimeter of the cable slack handling device, wherein the linear exterior wall portions of the first and second lobes are substantially parallel.

7. The device as defined by claim 1, wherein the connection device is selected from the group consisting of: mechanical splices, fusion splices, splitters, couplers, connectors, and passive optical devices.

8. The device as defined by claim 1, wherein a portion of at least one of the interior walls of each lobe is arcuate and has a radius of curvature of less than about 30 mm.

9. The device as defined by claim 1, wherein the connection device holder is positioned at an angle relative to the base portion such that the connection device holder is adapted to direct an input end of the cables in an input path around the exterior wall portions of the lobes and adapted to direct an output end of the cables in an output path around the exterior wall portions of the lobes to thereby separate the input path of the input end of the cables from the output path of the output end of the cables.

10. The device as defined by claim 9, further comprising a plurality of protuberances extending radially outward from the exterior wall portion of the lobes comprising at least one center protuberance, at least one first protuberance on one side of the center protuberance, and at least one second protuberance on the other side of the center protuberance, wherein the space between the first protuberances and the center protuberances defines the input path, and wherein the space between the second protuberances and the center protuberances defines the output path.

11. A cable slack handling device comprising:
a base portion;
a plurality of cables each containing one or more optical fibers;
a plurality of connection devices for connecting the fibers; and
a first lobe and a second lobe each joined with the base portion;
at least one arcuate exterior wall portion on each of the first and second lobes, the arcuate exterior wall portions to accommodate cable slack around a perimeter of the device;
at least two interior wall portions on each of the first and second lobes defining a first channel and a second channel disposed between the first and second lobes, the first and second channels adapted to receive one or more cables; and
a connection device holder disposed between at least a portion of the first and second lobes and disposed between at least a portion of the first and second channels, the connection device holder adapted to contain one or more connection devices that receive the cables from the channels.

12. The device as defined by claim 11, wherein the one or more connection devices is selected from the group consisting of: mechanical splices, fusion splices, splitters, couplers, connectors, and passive optical devices.

13. The device as defined by claim 11, wherein the cables comprise multi-fiber cables.

14. The device as defined by claim 11, wherein the connection device holder is positioned at an angle relative to the base portion such that the connection device holder directs an input end of the cables in an input path around the exterior wall portions of the lobes and directs an output end of the cables in an output path around the exterior wall portions of the lobes to thereby separate the input path of the input end of the cables from the output path of the output end of the cables.

15. The device as defined by claim 14, further comprising a plurality of protuberances extending radially outward from the exterior wall portion of the lobes comprising at least one center protuberance, at least one first protuberance on one side of the center protuberance, and at least one second protuberance on the other side of the center protuberance, wherein the space between the first protuberances and the center protuberances defines the input path, and wherein the space between the second protuberances and the center protuberances defines the output path.

16. A system for handling cable slack comprising:
a housing; and
a cable slack handling device mounted to the housing, the cable slack handling device comprising:
a base portion;
one or more cables containing one or more optical fibers;
a plurality of connection devices for connecting the fibers;
a first lobe and a second lobe each joined with the base portion;
at least one arcuate exterior wall portion on each of the first and second lobes, the arcuate exterior wall portions to accommodate cable slack around a perimeter of the device;
at least two interior wall portions on each of the first and second lobes defining a first channel and a second channel disposed between the first and second lobes, the first and second channels adapted to receive one or more cables; and
a connection device holder disposed between at least a portion of the first and second lobes and disposed between at least a portion of the first and second channels, the connection device holder adapted to contain one or more connection devices that receive the cables from the channels.

17. The device as defined by claim 16, wherein the cable slack handling device is rotatably mounted to the housing.

18. The device as defined by claim 16, wherein the housing comprises a drawer adapted to facilitate connection to telecommunications equipment.

19. The device as defined by claim 16, wherein the housing comprises a connection device tray adapted to facilitate connection between one set of telecommunication lines and another set of telecommunication lines.
